(19) United States
(12) Patent Application Publication
(10) Pub. No.: US 2021/0398420 A1
(43) Pub. Date: Dec. 23, 2021

(54) MOVING BODY MONITORING SYSTEM, CONTROL SERVER OF MOVING BODY MONITORING SYSTEM, AND MOVING BODY MONITORING METHOD

(71) Applicant: IHI Corporation, Tokyo (JP)

(72) Inventors: Shota FUJISAWA, Tokyo (JP); Kenichi HAMAGUCHI, Tokyo (JP); Akira KOBAYASHI, Tokyo (JP)

(73) Assignee: IHI Corporation, Tokyo (JP)

(21) Appl. No.: 17/466,039

(22) Filed: Sep. 3, 2021

Related U.S. Application Data
(63) Continuation of application No. PCT/JP2020/010714, filed on Mar. 12, 2020.

(30) Foreign Application Priority Data
Mar. 19, 2019 (JP) 2019-050736

(51) Int. Cl. G08G 1/01; G08G 1/052; G08G 1/056; G08G 1/08; G08G 1/083; G01S 17/89

(52) U.S. Cl. CPC G08G 1/0145; G08G 1/0116; G08G 1/052; G01S 17/89; G08G 1/08; G08G 1/083; G08G 1/056

(57) ABSTRACT

A system includes: a laser radar irradiating a detection region and detecting a reflected signal of the laser by a moving body in the detection region at a predetermined cycle, a vehicle detecting unit detecting a vehicle existing in the detection region based on the reflected signal detected by the laser radar, a vehicle tracking unit setting a plurality of divided regions in the detection region and detecting a moving direction of the vehicle based on a presence or absence of the vehicle in each of the divided regions detected by the vehicle detecting unit at each predetermined cycle, and a traffic flow calculating unit calculating a traffic flow data including a number of vehicles in each of the divided regions detected by the vehicle detecting unit and the moving direction of each vehicle detected by the vehicle tracking unit.

### CROSS REFERENCE TO RELATED APPLICATIONS

This application is a continuation application of International Application No. PCT/JP2020/010714, filed on Mar. 12, 2020, which claims priority to Japanese Patent Application No. 2019-050736 filed on Mar. 19, 2019, the entire contents of which are incorporated by reference herein.

### TECHNICAL FIELD

The present invention relates to a moving body monitoring system, a control server of the moving body monitoring system, and a moving body monitoring method.

### BACKGROUND ART

Japanese Patent Application Publication No. 2010-197341 (Patent Literature 1) discloses a system for investigating the traffic volume and congestion of vehicles at an intersection. The system uses a laser radar installed at the intersection to detect a moving body, determine which vehicles enter and exit the intersection, and measure traffic flow through the intersection.

### SUMMARY OF THE INVENTION

### Technical Problem

However, according to the technique described in Patent Literature 1, described above cannot detect the direction of a vehicle traveling on a traveling path, the direction of a vehicle entering the intersection, and the direction of a vehicle exiting the intersection with high accuracy. That is, there is a problem that it is not possible to obtain information such as from which lane of the road connecting to the intersection to enter the intersection or from which direction the lane is congested.

An object of the present invention is to provide a moving body monitoring system, a control server of the moving body monitoring system, and a moving body monitoring method, capable of monitoring a moving body traveling on a traveling path with high accuracy.

### Solution to Problem

A moving body monitoring system according to the present disclosure is a moving body monitoring system that monitors a moving body traveling on a traveling path. The moving body monitoring system includes: a laser radar configured to irradiate a predetermined region set on the traveling path with a laser, and to detect a reflected signal of the laser by an object in the predetermined region at a predetermined cycle, a moving body detecting unit configured to detect a moving body existing in the predetermined region based on the reflected signal detected by the laser radar, a moving direction detecting unit configured to set a plurality of divided regions in the predetermined region and to detect a moving direction of the moving body based on a presence or absence of the moving body in each of the divided regions detected by the moving body detecting unit at each predetermined cycle, and a traffic flow calculating unit configured to calculate a traffic flow data including a number of moving bodies in each of the divided regions detected by the moving body detecting unit and the moving direction of each moving body detected by the moving direction detecting unit.

A control server according to the present disclosure is a control server of the moving body monitoring system that monitors a moving body traveling on a traveling path. The control server includes: a moving body detecting unit configured to detect a moving body existing in a predetermined region based on a reflected signal detected by a laser radar which irradiates the predetermined region set on the traveling path with a laser and detects the reflected signal of the laser by an object in the predetermined region at a predetermined cycle, a moving direction detecting unit configured to set a plurality of divided regions in the predetermined region and to detect a moving direction of the moving body based on a presence or absence of the moving body in each of the divided regions detected by the moving body detecting unit at each predetermined cycle, and a traffic flow calculating unit configured to calculate a traffic flow data including a number of moving bodies in each of the divided regions detected by the moving body detecting unit and the moving direction of each moving body detected by the moving direction detecting unit.

A moving body monitoring method according to the present disclosure is a moving body monitoring method that monitors a moving body traveling on a traveling path. The moving body monitoring method includes: a step of irradiating a predetermined region set on the traveling path with a laser, and detecting a reflected signal of the laser by an object in the predetermined region at a predetermined cycle, a step of detecting a moving body existing in the predetermined region based on the reflected signal, a step of setting a plurality of divided regions in the predetermined region and detecting a moving direction of the moving body based on a presence or absence of the moving body in each of the divided regions at each predetermined cycle, and a step of calculating a traffic flow data including a number of moving bodies in each of the divided regions and the moving direction of each moving body.

### Advantageous Effects of Invention

According to the present invention, it is possible to monitor a moving body traveling on a traveling path with high accuracy.

### BRIEF DESCRIPTION OF DRAWINGS

FIG. 1 is a block diagram illustrating a configuration of a moving body monitoring system according to the disclosure of the present invention.

FIG. 2A is a plan view illustrating a laser radar provided at a facing passage road and a detection region of the laser radar.

FIG. 2B is a bird's-eye view illustrating a laser radar provided at the facing passage road and the detection region of the laser radar.

FIG. 3A is a plan view illustrating a laser radar provided at an intersection and a detection region of the laser radar.

FIG. 3B is a bird's-eye view illustrating a laser radar provided at the intersection and the detection region of the laser radar.

FIG. 4 is an explanatory diagram illustrating a first example of traffic flow data stored in the database.

FIG. 5 is an explanatory diagram illustrating a second example of traffic flow data stored in the database.

FIG. 6 is a flowchart illustrating a processing procedure of a moving body monitoring system according to a first embodiment.

FIG. 7 is a flowchart illustrating a detailed procedure of a calculation and a recording process of the traffic flow data, the detailed procedure shown in S15 of FIG. 6.

FIG. 8 is a flowchart illustrating a detailed procedure of a deletion process of the traffic flow data, the detailed procedure shown in S16 of FIG. 6.

FIG. 9 is a flowchart illustrating a processing procedure of a moving body monitoring system according to a second embodiment.

FIG. 10A is an explanatory diagram illustrating an intersection where the traffic flow is monitored by the moving body monitoring system according to the second embodiment.

FIG. 10B is an explanatory diagram illustrating a plurality of divided regions set in a region of the intersection shown in FIG. 10A.

FIG. 11 is an explanatory diagram showing the ratio of vehicles present in the divided region shown in FIG. 10B.

### DESCRIPTION OF EMBODIMENTS

Hereinafter, some exemplary embodiments will be described with reference to the drawings.

### Explanation of First Embodiment

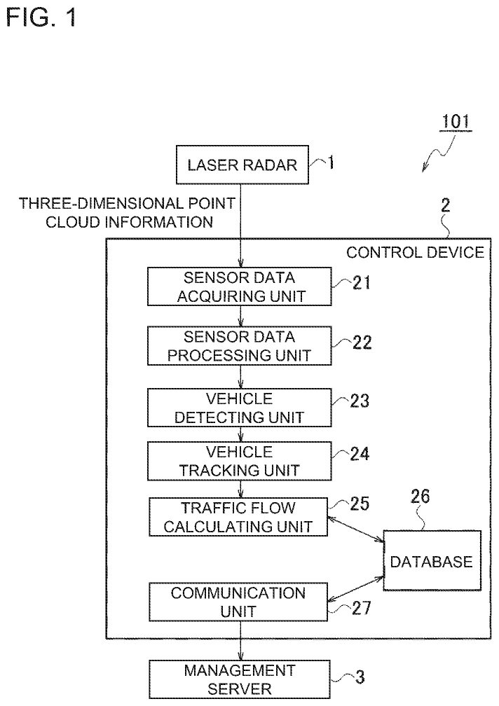

FIG. 1 is a block diagram illustrating a configuration of the moving body monitoring system according to the first embodiment. As shown in FIG. 1, the moving body monitoring system 101 according to the present disclosure monitors information on various moving body such as the number of moving bodies traveling on a traveling path, a moving direction, and a moving speed. The moving body monitoring system 101 includes a laser radar 1 provided at the traveling path on which the moving body travels, a control device 2 (control server) connected to the laser radar 1, and a management server 3 connected to the control device 2. The “moving body” described in the present disclosure is a concept including a vehicle (automobile or motorcycle), a bicycle, and a pedestrian. The “traveling path” is a concept that includes roads through which the moving body passes and intersections such as crossroads, junctions, and three-way junctions.

The laser radar 1 irradiates the laser toward a predetermined region set on the traveling path, detects the reflected signal of the laser by an object existing in the predetermined region at a predetermined cycle, and further acquires three-dimensional point cloud information by clustering the reflected signal. Further, the laser radar 1 outputs the acquired three-dimensional point cloud information (reflection signal) as sensor data to the control device 2. Based on the sensor data detected by the laser radar 1, the size and shape of the detected object can be detected. Therefore, as will be described later, it is possible to determine the type of the moving body traveling on the traveling path or the moving body stopped on the traveling path, that is, the type of the vehicle, the bicycle, the pedestrian, etc., based on the sensor data.

Further, since the laser radar 1 can acquire three-dimensional data of the moving body, the laser radar 1 has the advantage that the mounting position of the laser radar 1 is relatively low compared to a position for a method of capturing and detecting the moving body with a camera such as a visible camera or an infrared camera. In the method of installing the visible camera or the infrared camera on the traveling path to detect the moving body, it is necessary to install the camera at a relatively high position to take a bird's-eye view of the traveling path. On the other hand, the laser radar 1 does not need to be mounted at a high position. In the present disclosure, a vehicle will be described as an example of the moving body.

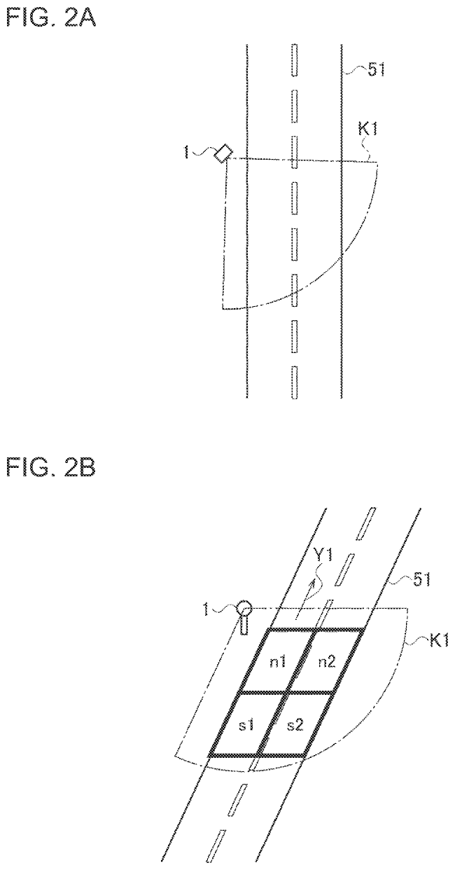

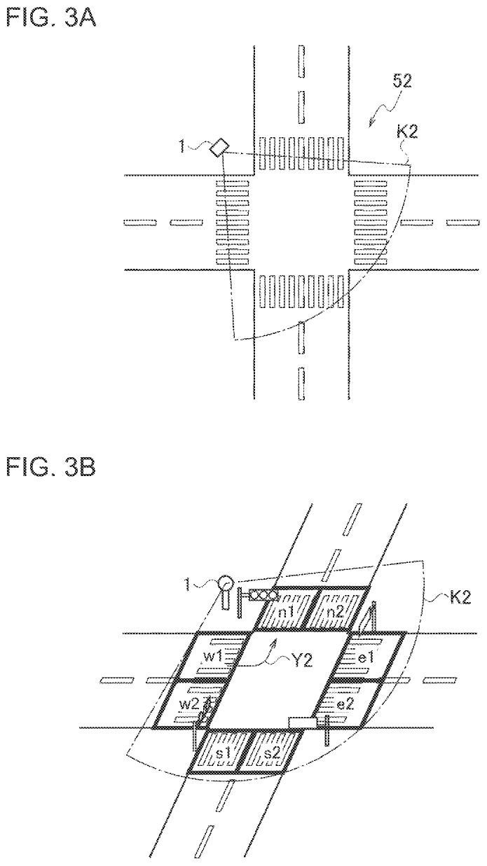

FIGS. 2A, 2B, 3A, and 3B are explanatory views illustrating installation locations of the laser radar 1 and detection regions by the laser radar 1.

FIGS. 2A and 2B illustrate examples in which a laser radar 1 is provided at a facing traveling path 51 having one lane on each side to monitor a vehicle, FIG. 2A illustrates a plan view, and FIG. 2B illustrates a bird's-eye view. As shown in FIG. 2A, a detection region K1 can be set in the facing traveling path 51 by one laser radar 1 provided at the side of the facing traveling path 51. Further, as shown in FIG. 2B, four divided regions n1, n2, s1 and s2 are set in each lane of the facing traveling path 51, and a moving body is detected in each divided region. The divided regions are not limited to four, and may be a plurality of divided regions.

FIGS. 3A and 3B illustrate examples in which a laser radar 1 is provided at an intersection (four-forked road) to monitor a vehicle, FIG. 3A illustrates a plan view, and FIG. 3B illustrates a schematic bird's-eye view. As shown in FIG. 3A, a detection region K2 can be set at the intersection 52 by one laser radar 1 provided at the side of the intersection 52. Further, as shown in FIG. 3B, a total of eight divided regions n1, n2, w1, w2, s1, s2, e1, and e2 are set at the four intersection approach portions of each traveling path at the intersection 52, and vehicles are detected in each divided region. The details will be described later.

Returning to FIG. 1, the control device 2 includes a sensor data acquiring unit 21, a sensor data processing unit 22, a vehicle detecting unit 23, a vehicle tracking unit 24, a traffic flow calculating unit 25, a database 26, and a communication unit 27. The control device 2 is connected to the laser radar 1 by wire or wirelessly. For example, the control device 2 can be installed in a base station that comprehensively manages traffic volume, and can be connected to the laser radar 1 via a wire, wireless, or network. Of course, the control device 2 may be provided near the side portion of the laser radar 1. The control device 2 can be configured as an integrated computer including a central processing unit (CPU) and storage means such as a RAM, a ROM, and a hard disk.

The sensor data acquiring unit 21 acquires three-dimensional point cloud information (sensor data) outputted from the laser radar 1.

The sensor data processing unit 22 performs a process of reducing unnecessary data from the sensor data acquired by the sensor data acquiring unit 21.

The vehicle detecting unit 23 (moving body detecting unit) detects a moving body existing in the predetermined region based on the sensor data (reflected signal) output from the sensor data processing unit 22. Further, the vehicle detecting unit 23 measures the size and shape of each moving body based on the sensor data, and determines the type of the moving body based on the measurement result. Specifically, when the lateral length of the sensor data detected by the laser radar 1 is equal to or longer than a preset constant length (for example, 2 meters), the vehicle detecting unit 23 determines that the moving body is a vehicle. Further, when the lateral length is longer than the above-mentioned vehicle, the vehicle detecting unit 23 determines that the vehicle is a large vehicle (truck or the like). Furthermore, it is possible to determine motorcycles and pedestrians. It is also possible to determine the type of the moving body by detecting at least one of the size and shape of the moving body.

The vehicle tracking unit 24 (moving direction detecting unit) assigns a vehicle ID for identifying each vehicle to the vehicle detected by the vehicle detecting unit 23. Then, by tracking the movement of each vehicle on the image, the moving direction and moving speed of the vehicle are detected based on the vehicle ID of each vehicle. For example, when the four divided regions n1, n2, s1 and s2 shown in FIG. 2B are set and the vehicle is detected in the divided region s1 and then detected in the divided region n1, the vehicle tracking unit 24 determines that the vehicle moves in the direction of the arrow Y1 shown in FIG. 2B. (The length (in road extension direction) of the divided region is, for example, 1 meter. The same applies to the divided region of FIG. 3).

Further, when the eight divided regions n1, n2, w1, w2, s1, s2, e1, and e2 shown in FIG. 3B are set and the vehicle is detected in the divided region w1 and then detected in the divided region n1, the vehicle tracking unit 24 determines that the vehicle moves in the direction of the arrow Y2 shown in FIG. 3B.

Further, the moving speed of the vehicle can be detected based on the relationship between the amount of change in the position of the vehicle based on the sensor data in each frame by the laser radar 1 and the passage of time.

That is, the vehicle tracking unit 24 has a function as the moving direction detecting unit that sets the plurality of divided regions in the predetermined region and detects the moving direction of the vehicle based on the presence or absence of the vehicle in each divided region detected by the vehicle detecting unit 23 at the predetermined cycle.

Further, the vehicle tracking unit 24 has a function of determining whether the vehicles that are detected at different timings are same based on at least one of the size and shape of each vehicle detected by the vehicle detecting unit 23 at different timings (in other words, different times) in the predetermined cycle, and detecting the moving direction of the vehicles that are determined to be the same.

Further, the vehicle tracking unit 24 detects the speed of each vehicle based on the position of each vehicle detected by the vehicle detecting unit 23 at different timings of the predetermined cycle. The vehicle tracking unit 24 outputs the detected speed to the traffic flow calculating unit 25.

The traffic flow calculating unit 25 creates traffic flow data indicating the movement status of the vehicle detected by the vehicle detecting unit 23 and given the vehicle ID. For example, in the case where the detection region K1 is set in the facing travel path 51 as shown in FIG. 2B, the traffic flow calculating unit 25 creates traffic flow data including each information of the vehicle ID of the vehicle traveling in the detection region K1, the vehicle type (ordinary vehicle, large vehicle, etc.), traveling time, a first detected divided region, a last detected divided region, the traveling direction of the vehicle, and the traveling speed of the vehicle.

That is, the traffic flow calculating unit 25 has a function of calculating the traffic flow data which is the data including the number of vehicles in each divided region detected by the vehicle detecting unit 23 and the moving direction of the vehicles in a predetermined time or a unit time.

Further, the traffic flow calculating unit 25 detects the number of vehicles existing in each divided region within the predetermined time by the vehicle detecting unit 23, and creates a density map indicating the density of vehicles existing in each divided region within the predetermined time. The details of the density map will be described later.

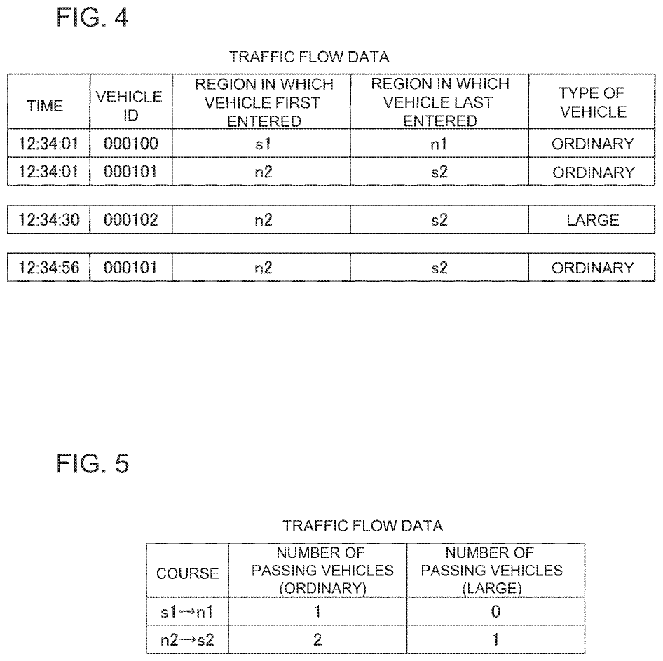

The database 26 stores the traffic flow data outputted from the traffic flow calculating unit 25. FIG. 4 is an explanatory diagram illustrating an example of traffic flow data. As shown in FIG. 4, the traffic flow data includes the time when the vehicle traveled (for example, 12:34:01), the vehicle ID (for example, 000100), and the area where the vehicle was first detected (for example, s1), the area where the vehicle was last detected (for example, n1), and the type of vehicle (for example, ordinary vehicle). In FIG. 4, the speed of each vehicle is omitted.

Further, the data of the number of passing vehicles for each desired time zone is stored. FIG. 5 is an explanatory diagram illustrating the number of passing vehicles in each time zone, and data showing a course (for example, from s1 to n1), the number of passing ordinary vehicles, and the number of passing large vehicles is stored. The above traffic flow data stored in the database 26 is deleted after a predetermined storage period has elapsed. The data storage period can be set to any period such as one week, one month, and one year.

Therefore, the database 26 stores the traffic flow data for the latest fixed period (the above-mentioned storage period). In other words, the traffic flow calculating unit 25 stores the traffic flow data in the database 26, and deletes the traffic flow data stored in the database 26 when a certain period of time elapses. Further, the traffic flow calculating unit 25 deletes the traffic flow data when the traffic flow data stored in the database 26 is transmitted to the management server 3 via the communication unit 27.

Note that the traffic flow data may not be deleted automatically, but may be deleted by an operation by an operator such as an administrator of the device.

Returning to FIG. 1, the communication unit 27 can communicate with the management server 3, reads the traffic flow data stored in the database 26 in response to a search request from the management server 3, and sends the read traffic flow data to the management server 3. For example, in a case where a request for outputting lighting data of a traffic signal for determining a lighting time of the traffic signal provided at a predetermined intersection occurs as the search request from the management server 3, the lighting time of the traffic signal is calculated based on the traffic flow data (the density map described later) calculated by the traffic flow calculating unit 25, the lighting data of the traffic signal indicating the calculated lighting time is transmitted to the management server 3. The details will be described later.

The management server 3 is connected to the control device 2 by wireless, wired, or network. Therefore, the installation position of the management server 3 can be arbitrarily determined. Of course, it can also be installed in the vicinity of the control device 2.

[Explanation of Operation of First Embodiment]

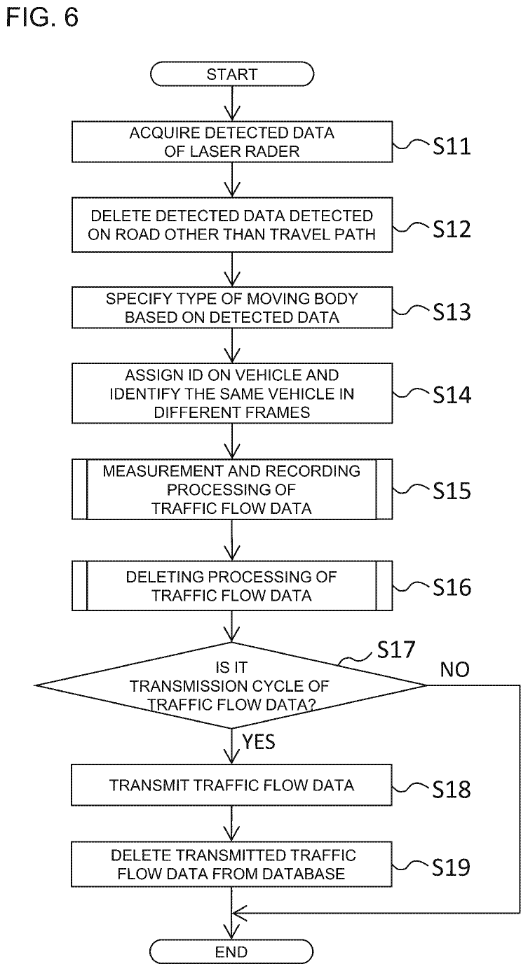

Next, the processing procedure of the moving body monitoring system 101 according to the first embodiment configured as described above will be described with reference to the flowcharts shown in FIGS. 6 to 8. The processes shown in FIGS. 6 to 8 are executed by the control device 2 shown in FIG. 1. In the present disclosure, as shown in FIGS. 2A and 2B described above, an example of monitoring a vehicle traveling on the facing traveling path 51 by the laser radar 1 provided at the side of the facing traveling path 51 will be described.

First, in step S11, the sensor data acquiring unit 21 acquires three-dimensional point cloud information (sensor data) detected in a desired detection region by the laser radar 1. For example, as shown in FIGS. 2A and 2B, in a case where the laser radar 1 is provided at the side of the facing traveling path 51, the sensor data acquiring unit 21 acquires the sensor data obtained from the moving body existing in the detection region K1. Further, as shown in FIGS. 3A and 3B, in a case where the laser radar 1 is provided at the side of the intersection 52, the sensor data acquiring unit 21 acquires the sensor data obtained from the moving body existing in the detection region K2.

In step S12, the sensor data processing unit 22 deletes the sensor data detected on a road other than the travel path (other than on the road) from the sensor data acquired by the sensor data acquiring unit 21. For example, in the example shown in FIGS. 2A and 2B, since it is not necessary to detect the moving body in a region other than the divided regions n1, n2, s1, and s2 shown in FIG. 2B (a region other than the traveling path), the sensor data processing unit 22 deletes the sensor data detected in the region other than the traveling path. In the example shown in FIGS. 3A and 3B, the sensor data processing unit 22 deletes the sensor data detected in the region outside the eight regions shown in FIG. 3B. (That is, the data in the region not included in the region K2 is deleted. The data in the intersection included in the region K2 is not deleted.) By this process, data that is not necessary for vehicle monitoring can be deleted, so that the amount of data can be reduced.

In step S13, the vehicle detecting unit 23 specifies the type of the moving body detected by the laser radar 1. For example, a type such as an ordinary vehicle or a large vehicle is specified.

In step S14, the vehicle tracking unit 24 assigns a vehicle ID for identifying each vehicle to the vehicle detected by the vehicle detecting unit 23. (For example, coordinate values on the frame and the ID are stored in association with each other.) Then, the vehicle tracking unit 24 identifies the same vehicle in different frames (detection data at different times) by tracking on the image. The period of the frame is, for example, about several microseconds to several milliseconds.

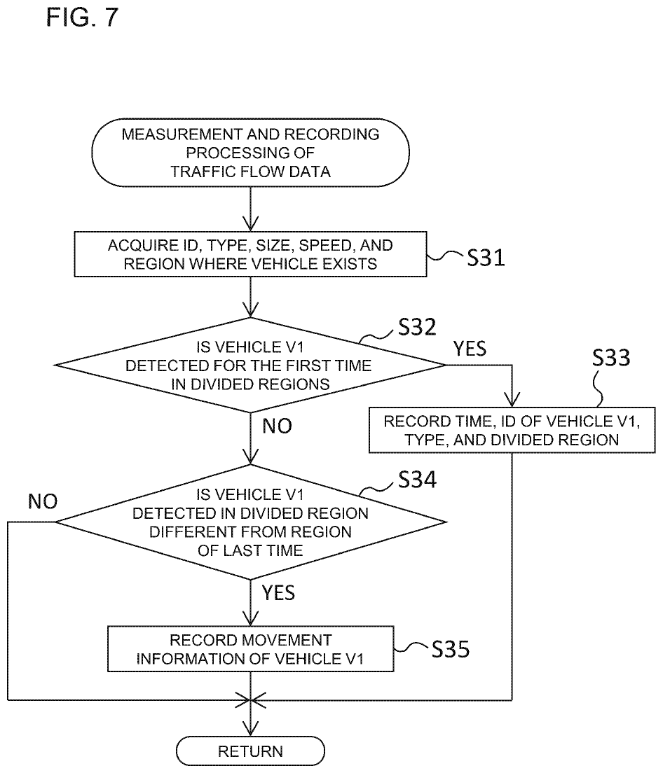

In step S15, the traffic flow calculating unit 25 measures and records the traffic flow data. Hereinafter, details of the measurement and recording processing of the traffic flow data will be described with reference to the flowchart shown in FIG. 7.

In step S31 shown in FIG. 7, the traffic flow calculating unit 25 selects one frame and acquires each data of the ID, type, size, speed, and region where the vehicle exists in this frame.

In step S32, it is determined whether the vehicle detected by the vehicle detecting unit 23 (referred to as vehicle V1) is detected for the first time in any of the divided regions set in the detection region K1. The divided regions are the divided regions n1, n2, s1, and s2 shown in FIG. 2B. For example, when the vehicle V1 is traveling in the direction of the arrow Y1 shown in FIG. 2B, the vehicle V1 is detected for the first time by the laser radar 1 when entering the divided region s1. Then, if it is detected for the first time (S32; YES), the process proceeds to step S33, and if it is not the first time (S32; NO), the process proceeds to step S34.

In step S33, the traffic flow calculating unit 25 records following data as traffic flow data: the time when the vehicle V1 is detected, the ID and type of the vehicle V1, and the divided region where the vehicle V1 is detected, that is, the divided regions such as s1 and n2 shown in FIG. 2B.

In step S34, the traffic flow calculating unit 25 determines whether the vehicle V1 is detected in a divided region different from the divided region (for example, s1) detected last time (in the previous frame). For example, when the vehicle V1 is moving in the direction of the arrow Y1 shown in FIG. 2B, the vehicle V1 moves from the divided region s1 to n1. In this case, it is determined that the detection was performed in a divided region different from the previous one.

Then, in a case where the vehicle V1 is detected in different divided regions (S34; YES), in step S35, the traffic flow calculating unit 25 calculates a movement information of the vehicle V1 and records the movement information in the traffic flow data. For example, in a case where the vehicle V1 is detected in the divided region s1 shown in FIG. 2B and then detected in the divided region n1, it is determined that the vehicle V1 is moving in the direction of the arrow Y1 shown in FIG. 2B. This movement information is recorded in the traffic flow data. After that, the traffic flow data is recorded in the database 26, the process returns to step S31, the next frame of the present frame is selected, and the same processing as described above is executed. Then, the above processing is performed on each vehicle (all vehicles) included in each frame detected by the laser radar 1, and this processing is terminated when the predetermined time elapses.

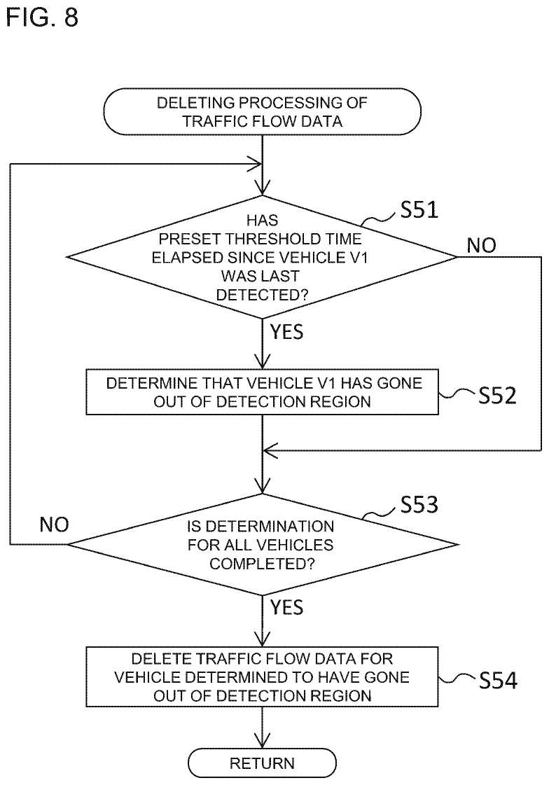

Returning to FIG. 6, in step S16, the traffic flow calculating unit 25 performs a process of deleting the traffic flow data from the database 26. Hereinafter, the details of this process will be described with reference to the flowchart shown in FIG. 8.

In step S51, the traffic flow calculating unit 25 determines whether a preset threshold time has elapsed since the vehicle V1 was last detected in any of the divided regions shown in FIG. 2B. For example, in a case where the vehicle V1 is detected in the divided region s1, then detected in the divided region n1, and then the vehicle V1 is not detected in all the divided regions s1, s2, n1, n2, that is, in the detection region K1, the time when it is no longer detected is stored, and the time counting is started from this point to determine whether the threshold time has elapsed.

In a case where the threshold time has elapsed (S51; YES), in step S52, the traffic flow calculating unit 25 determines that the vehicle V1 has gone out of the detection region K1.

In step S53, the traffic flow calculating unit 25 determines whether the determination for all vehicles has been completed, and if the determination for all vehicles has been completed (S53; YES), in step S54, the traffic flow calculating unit 25 deletes the traffic flow data for the vehicle determined to have gone out of the detection region K1, from the database 26. That is, the amount of data in the database 26 is reduced by deleting the traffic flow data for the vehicle that no longer needs to be detected. After that, this process ends.

Returning to FIG. 6, in step S17, the communication unit 27 determines whether the current time is a transmission cycle of the traffic flow data.

In a case where the current time is the transmission cycle (S17; YES), in step S18, the communication unit 27 transmits the traffic flow data stored in the database 26 to the management server 3. Therefore, the traffic flow data can be acquired on the management server 3. In the management server 3, for example, as shown in FIG. 4, in the detection region K1 shown in FIG. 2B, a following information is provided to the operator of the management server 3. The information indicates the time when the vehicle entered the detection region K1, the ID for identifying the vehicle, the divided region in which the vehicle first entered, the divided region in which the vehicle last entered, and the type of vehicle. Further, as shown in FIG. 5, data indicating the number of passing vehicles, the traveling direction of the vehicles, and the type of the vehicle in the predetermined time zone is provided to the operator of the management server 3.

After that, in step S19, the traffic flow calculating unit 25 deletes the traffic flow data transmitted to the management server 3 from the database 26. After that, this process ends.

[Explanation of Effect of First Embodiment]

In this way, the moving body monitoring system 101 according to the present disclosure detects the vehicle in a plurality of divided regions (for example, s1, s2, n1, n2 shown in FIG. 2B) in a desired detection region (K1 in the examples of FIGS. 2A and 2B, and K2 in the examples of FIGS. 3A and 3B), by using the laser radar 1. Therefore, it is possible not only to detect the vehicle passing through the detection region K1 but also to detect detailed data such as the traveling direction, speed, type of the vehicle, and stopped vehicle, and to create the traffic flow data.

Therefore, the operator of the management server 3 can recognize the traffic flow data within the desired detection region by the laser radar 1. In addition, the type and number of vehicles traveling in an arbitrary time zone (for example, the time zone from 7:00 am to 8:00 am) can be easily and accurately recognized in the predetermined detection region. Further, as compared with the case where the traffic flow is measured by personnel, the labor cost can be reduced, the measurement period can be shortened, and the measurement accuracy can be improved.

Further, since the moving body is measured by using the laser radar 1, the flexibility of the installation position can be improved as compared with the case of taking an image with a camera, for example. That is, when an image of a moving body traveling on a traveling path is taken by a camera, it is necessary to install the camera at a position (relatively high position) where the traveling path can be overlooked. However, in the present disclosure, since the moving body is detected by using the laser radar 1, the installation position of the laser radar 1 can be lowered, and the restriction on the installation position is relaxed.

Further, in a case where a moving body is imaged by a camera, a large calculation load is required for image analysis, but by using the laser radar 1, the calculation load for detecting the moving body can be reduced. Further, since the laser radar 1 has a wide detection region, it is possible to detect a moving body with only one laser radar 1, and further, it is not easily restricted by the road shape of the traveling path to be monitored.

Further, since the laser radar 1 is not easily affected by the surrounding environment such as rainy weather, backlight, nighttime, and in a tunnel, it is possible to stably acquire traffic flow data and it is not restricted by the installation location.

As shown in FIGS. 2A and 2B, the example in which the detection region K1 is set in the facing traveling path 51 and the traffic flow of the facing traveling path 51 is measured has been described. In addition, as shown in FIGS. 3A and 3B, it is possible to detect traffic flow at intersections. In the case of the example shown in FIGS. 3A and 3B, it is possible to detect from which direction the vehicle is coming from and leaving to by detecting a divided region that the vehicle passes through when entering the intersection and a divided region that the vehicle passes when the vehicle exits the intersection.

For example, in a case where the vehicle detected in the divided region w1 shown in FIG. 3B is subsequently detected in the divided region n1, it can be determined that the vehicle enters a intersection from the divided region w1 side and then leaves out the intersection by turning left to the divided region n1 side. Then, such traffic flow data can be created and provided to the operator of the management server 3. Therefore, the operator can recognize the route and the number of vehicles entering the intersection, and the route and the number of vehicles exiting the intersection, which are useful for setting the time of the traffic signal (red lighting time, green lighting time), for example.

[Explanation of Second Embodiment]

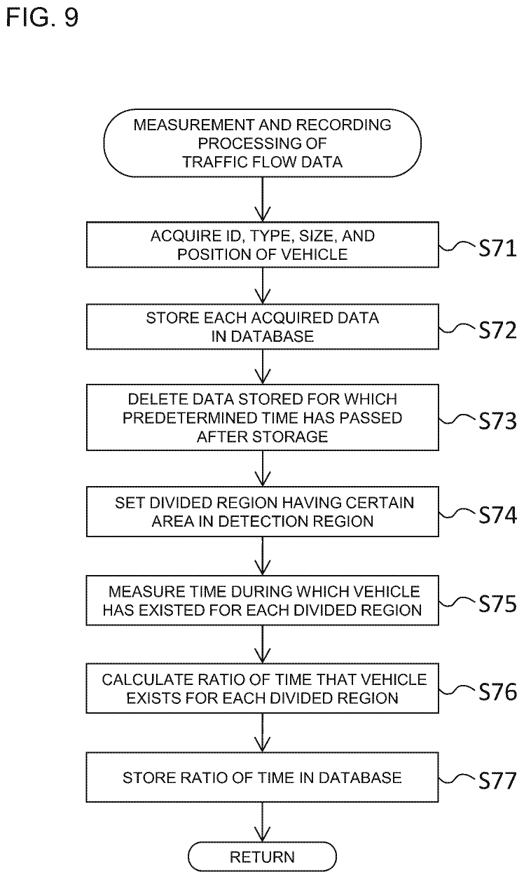

Next, the second embodiment will be described. Since the configuration of the moving body monitoring system according to the present disclosure is the same as that of FIG. 1 described above, the description of the configuration will be omitted. Further, regarding the processing operation, the calculation and deletion processing of the traffic flow data shown in step S15 of FIG. 6 described above is different. Therefore, the process of S15 will be described below with reference to the flowchart shown in FIG. 9.

In step S71, the traffic flow calculating unit 25 acquires the ID, type, size, speed, and existing position of the vehicle.

In step S72, the traffic flow calculating unit 25 stores each data acquired in the process of S71 in the database 26.

In step S73, the traffic flow calculating unit 25 deletes the data stored in the database 26 for which the predetermined time has passed after the storage. That is, since the data that has passed the predetermined time or more becomes unnecessary, the amount of data in the database 26 is reduced by deleting the data.

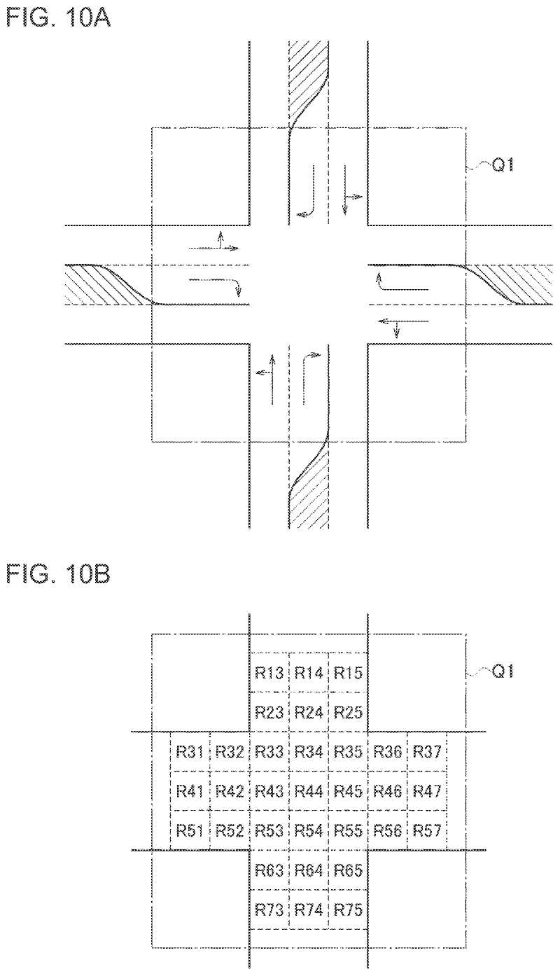

In step S74, the traffic flow calculating unit 25 sets a divided region having a certain area in the detection region for detecting the vehicle. Hereinafter, a method of setting the divided region will be described with reference to FIGS. 10A and 10B. For example, when the detection region of the vehicle is an intersection Q1 as shown in FIG. 10A, a plurality of rectangular divided regions are set at this intersection Q1. Specifically, as shown in FIG. 10B, rectangular divided regions R13 to R75 are set inside the intersection Q1 and at appropriate positions on the traveling path connected to the intersection Q1. At this time, the divided region is not set in the area deviating from the traveling path. Here, FIGS. 10A and 10B correspond to each other, and the nine divided regions, i.e. the divided regions R33, R34, R35, R43, R44, R45, R53, R54, and R55 shown in FIG. 10B correspond to the inside of the intersection Q1 shown in FIG. 10A.

In step S75, the traffic flow calculating unit 25 measures the time during which the vehicle has existed for each divided region within the predetermined time set in advance. For example, the predetermined time is set to 1 minute, and the time during which the vehicle is present in each divided region is measured in this 1 minute.

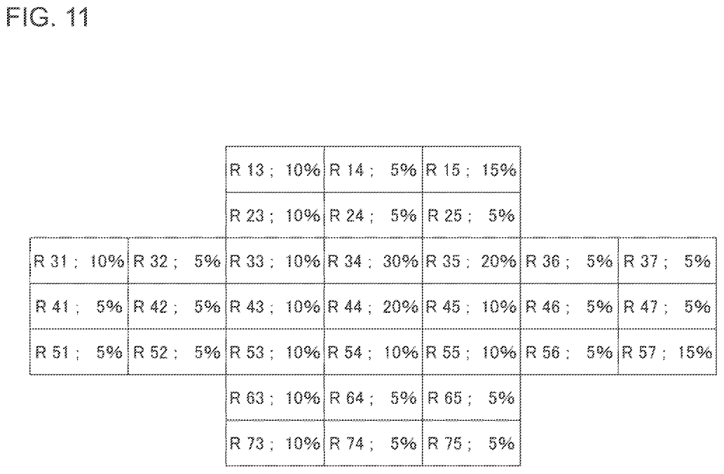

In step S76, the traffic flow calculating unit 25 calculates a ratio of the time that the vehicle exists for each divided region. For example, if the vehicle is present for only 6 seconds out of 1 minute in an arbitrary divided region, the ratio is 10%. The above ratio is calculated in each divided region shown in FIG. 10B, and a density map showing the ratio is created. Specifically, as shown in FIG. 11, the density map in which the ratio is entered for each divided region is created.

In step S77, the traffic flow calculating unit 25 stores the density map in which the ratio data is described in the database 26.

After that, as shown in step S18 of FIG. 6, the above density map is transmitted to the management server 3. As a result, the operator of the management server 3 can recognize the area where the vehicle is congested or the area where the vehicle frequently travels at the intersection Q1 by looking at the density map.

Further, the communication unit 27 may calculate an appropriate lighting time of the traffic signal provided at the intersection Q1 based on the above density map, and may transmit lighting data of the traffic signal indicating the calculated lighting time to the management server 3. That is, the density map described above makes it possible to recognize in which area within the intersection the vehicle is congested. Therefore, since it is possible to recognize which lane at the intersection Q1 is congested, the lighting data of the traffic signal is transmitted to the management server 3, wherein the lighting data includes information such as setting a long lighting time of the green light of the traffic light corresponding to this lane. The management server 3 controls the lighting time of the traffic signal, and can set the lighting time of the green light and the red light to an appropriate time.

In this way, the moving body monitoring system according to the present disclosure sets a plurality of divided regions in the intersection Q1 and the traveling path around the intersection, and creates a density map showing the ratio of the time when the vehicle exists in each divided region. Therefore, the operator can recognize the congestion situation in the intersection Q1 by looking at this density map. Therefore, for example, in a case where the presence ratio of vehicles is large in a specific traveling path region, it can be recognized that many vehicles traveling on this traveling path are waiting for a signal at the intersection. Therefore, it is possible to easily recognize measures such as setting a long lighting time of the green light of the traffic signal in the traveling direction of the traveling path. That is, it can be used as data when setting the lighting time of the green light and the lighting time of the red light in the traffic signal.

In addition, in a case where the congestion situation is different depending on the day and time zone, for example, it is also possible to control the lighting time of the traffic signal, i.e. the lighting time of the green light and the red light to be changed in real time for each time zone, by using the congestion state of each divided region in the morning commuting time zone and the congestion state of each divided region in the daytime time zone. Therefore, it can contribute to alleviating traffic congestion of vehicles at intersections.

It is needless to mention that the present disclosure also includes various embodiments that are not described herein. Therefore, the technical scope of the present disclosure is to be defined only by the invention specifying matters according to the scope of claims appropriately obtained from the above descriptions.

Each function shown in the present disclosure may be implemented by one or more processing circuits. The processing circuit includes a programmed processing device such as a processing device including an electric circuit. Processing devices also include devices such as application specific integrated circuits (ASIC) and conventional circuit components arranged to perform the functions described in the embodiments.

### REFERENCE SIGNS LIST

1 laser radar

2 control device

3 management server

21 sensor data acquiring unit

22 sensor data processing unit

23 vehicle detecting unit (moving body detecting unit)

24 vehicle tracking unit

25 traffic flow calculating unit

26 database

27 communication unit

51 facing traveling path

52 intersection

101 moving body monitoring system

1. A moving body monitoring system that monitors a moving body traveling on a traveling path, comprising:
a laser radar configured to irradiate a predetermined region set on the traveling path with a laser, and to detect a reflected signal of the laser by an object in the predetermined region at a predetermined cycle;
a moving body detecting unit configured to detect a moving body existing in the predetermined region based on the reflected signal detected by the laser radar;
a moving direction detecting unit configured to set a plurality of divided regions in the predetermined region and to detect a moving direction of the moving body based on a presence or absence of the moving body in each of the divided regions detected by the moving body detecting unit at each predetermined cycle; and
a traffic flow calculating unit configured to calculate a traffic flow data including a number of the moving body in each of the divided regions detected by the moving body detecting unit and the moving direction of each moving body detected by the moving direction detecting unit.

2. The moving body monitoring system according to claim 1, wherein
the moving body detecting unit detects at least one of a size and a shape of the moving body based on the reflected signal,
the moving direction detecting unit
determines whether the moving bodies that are detected at different timings are same based on at least one of the size and the shape of each moving body detected by the moving body detecting unit at different timings in the predetermined cycle, and
detects the moving direction of the moving bodies that are determined to be the same.

3. The moving body monitoring system according to claim 1, wherein
the moving body detecting unit
detects at least one of a size and a shape of the moving body based on the reflected signal, and
determines a type of the moving body based on at least one of the size and the shape of the moving body.

4. The moving body monitoring system according to claim 1, wherein
the moving direction detecting unit detects a speed of each moving body based on a position of each moving body detected by the moving body detecting unit at different timings of the predetermined cycle, and
the traffic flow data includes the speed of each moving body.

5. The moving body monitoring system according to claim 1, wherein
the traffic flow calculating unit
detects a number of the moving body existing in each of the divided regions within a predetermined time by using the moving body detecting unit, and
creates a density map showing a density of the moving body existing in each of the divided regions within the predetermined time.

6. The moving body monitoring system according to claim 1, wherein
the traveling path is an intersection having a traffic signal, and
the moving body monitoring system is provided with a communication unit configured
to calculate a lighting time of the traffic signal based on the traffic flow data calculated by the traffic flow calculating unit and
to transmit a traffic signal lighting data indicating the calculated lighting time.

7. A control server of a moving body monitoring system that monitors a moving body traveling on a traveling path, comprising:
a moving body detecting unit configured to detect a moving body existing in a predetermined region based on a reflected signal detected by a laser radar which irradiates the predetermined region set on the traveling path with a laser and detects the reflected signal of the laser by an object in the predetermined region at a predetermined cycle;
a moving direction detecting unit configured to set a plurality of divided regions in the predetermined region and to detect a moving direction of the moving body based on a presence or absence of the moving body in each of the divided regions detected by the moving body detecting unit at each predetermined cycle; and
a traffic flow calculating unit configured to calculate a traffic flow data including a number of the moving body in each of the divided regions detected by the moving body detecting unit and the moving direction of each moving body detected by the moving direction detecting unit.

8. A moving body monitoring method that monitors a moving body traveling on a traveling path, comprising:
a step of irradiating a predetermined region set on the traveling path with a laser, and detecting a reflected signal of the laser by an object in the predetermined region at a predetermined cycle;
a step of detecting a moving body existing in the predetermined region based on the reflected signal;
a step of setting a plurality of divided regions in the predetermined region and detecting a moving direction of the moving body based on a presence or absence of the moving body in each of the divided regions at each predetermined cycle; and
a step of calculating a traffic flow data including a number of the moving body in each of the divided regions and the moving direction of each moving body.
